(19) United States
(12) Patent Application Publication
(10) Pub. No.: US 2019/0211922 A1
(43) Pub. Date: Jul. 11, 2019

(54) SHIFT DEVICE

(71) Applicant: KABUSHIKI KAISHA TOKAI-RIKA-DENKI-SEISAKUSHO, Aichi-ken (JP)

(72) Inventor: Masayuki BABA, Aichi-ken (JP)

(21) Appl. No.: 16/232,406

(22) Filed: Dec. 26, 2018

(30) Foreign Application Priority Data
Jan. 5, 2018 (JP) 2018-000842

(51) Int. Cl. F16H 61/22; F16H 59/10; F16H 19/04

(52) U.S. Cl. CPC F16H 61/22; F16H 19/04; F16H 59/10

(57) ABSTRACT

A shift device of the present disclosure includes a shift body that is moved to change a shift position, a restriction body that is moved toward one side to restrict movement of the shift body from a predetermined shift position, and that is moved toward another side to release restriction of the movement of the shift body from the predetermined shift position, a moving gear that is capable of rotating, and a sliding body that meshes with the moving gear, and that slides by the moving gear being rotated so as to move the restriction body.

### CROSS-REFERENCE TO RELATED APPLICATION

This application is based on and claims priority under 35 USC 119 from Japanese Patent Application No. 2018-000842 filed on Jan. 5, 2018, the disclosure of which is incorporated by reference herein.

### BACKGROUND

### Technical Field

The present disclosure relates to a shift device in which a shift body is moved to change a shift position.

### Related Art

Japanese National-Phase Publication No. 2016-539836 discloses a shift device in which a locking element is moved from a first position to a second position to engage with a locking contour of an operating element, thereby restricting rotation of the operating element from a P position. Furthermore, the locking element is moved from the second position to the first position to disengage from the locking contour of the operating element, thereby releasing the restriction on rotation of the operating element from the P position.

In this shift device, a protrusion of the locking element engages with a control contour of an adjustment ring, and the adjustment ring is rotated to move the locking element.

### SUMMARY

In consideration of the above circumstances, the present disclosure provides a shift device capable of increasing the precision of movement speed of a restriction body.

### Solution to Problem

A shift device of a first aspect of the present disclosure includes a shift body that is moved to change a shift position, a restriction body that is moved toward one side to restrict movement of the shift body from a predetermined shift position, and that is moved toward another side to release restriction of the movement of the shift body from the predetermined shift position, a moving gear that is capable of rotating, and a sliding body that meshes with the moving gear, and that slides by the moving gear being rotated so as to move the restriction body.

A shift device of a second aspect of the present disclosure is the shift device of the first aspect of the present disclosure, further including an inclined face that is provided to at least one out of the restriction body or the sliding body, that is inclined with respect to a slide direction of the sliding body, and that by engaging with the other out of the restriction body or the sliding body slides the sliding body to move the restriction body.

A shift device of a third aspect of the present disclosure is the shift device of the first aspect or the second aspect of the present disclosure, wherein the sliding body slides at a rotation-circumferential direction side or a rotation-axial direction side of the shift body.

A shift device of a fourth aspect of the present disclosure is the shift device of any one of the first aspect to the third aspect of the present disclosure, wherein the sliding body slides to move plural of the restriction bodies.

In the shift device of the first aspect of the present disclosure, the shift body is moved to change the shift position. The restriction body is moved toward the one side to restrict movement of the shift body from the predetermined shift position, and the restriction body is moved toward the other side to release the restriction on the movement of the shift body from the predetermined shift position.

The moving gear and the sliding body mesh with each other, and the sliding body slides by the moving gear being rotated so as to move the restriction body. This enables the precision of the slide speed of the sliding body with respect to the rotation speed of the moving gear to be increased, enabling the precision of the movement speed of the restriction body to be increased.

In the shift device of the second aspect of the present disclosure, the inclined face provided to at least one out of the restriction body or the sliding body is inclined with respect to the slide direction of the sliding body, and by engaging with the other out of the restriction body or the sliding body, the inclined face slides the sliding body to move the restriction body. This enables the movement speed of the restriction body to be easily adjusted.

In the shift device of the third aspect of the present disclosure, the sliding body slides at a rotation-circumferential direction side or a rotation-axial direction side of the shift body. This enables the shift device to be made smaller in size in a rotation-radial direction of the shift body.

In the shift device of the fourth aspect of the present disclosure, the sliding body slides to move the plural restriction bodies. This enables a configuration in which the plural restriction bodies are moved to be simplified.

### BRIEF DESCRIPTION OF THE DRAWINGS

Exemplary embodiments of the present disclosure will be described in detail based on the following figures, wherein:

FIG. 1A is a plan view illustrating a shift device according to a first exemplary embodiment of the present disclosure as viewed from above, illustrating a state in which rotation of a knob from a P position has been locked

FIG. 1B is a plan view illustrating a shift device according to the first exemplary embodiment of the present disclosure as viewed from above, illustrating a state in which locking of rotation of a knob from a P position has been released;

FIG. 2A is a perspective view of a shift device according to the first exemplary embodiment of the present disclosure as viewed obliquely from the rear right, illustrating a state in which rotation of a knob from a P position has been locked

FIG. 2B is a perspective view of a shift device according to the first exemplary embodiment of the present disclosure as viewed obliquely from the rear right, illustrating a state in which locking of rotation of a knob from a P position has been released;

FIG. 3A is a side view illustrating a shift device according to a second exemplary embodiment of the present disclosure as viewed from the right, illustrating a state in which rotation of a lever from a P position has been locked;

FIG. 3B is a side view illustrating a shift device according to the second exemplary embodiment of the present disclosure as viewed from the right, illustrating a state in which locking of rotation of a lever from a P position has been released;

FIG. 4A is a side view illustrating a shift device according to the second exemplary embodiment of the present disclosure as viewed from the right, illustrating a state in which rotation of a lever from an N position has been locked;

FIG. 4B is a side view illustrating a shift device according to the second exemplary embodiment of the present disclosure as viewed from the right, illustrating a state in which locking of rotation of a lever from an N position has been released; and

FIG. 5 is a side view illustrating a shift device according to the second exemplary embodiment of the present disclosure as viewed from the right, illustrating a state in which rotation of a lever from a D position has been locked.

### DETAILED DESCRIPTION

### First Exemplary Embodiment

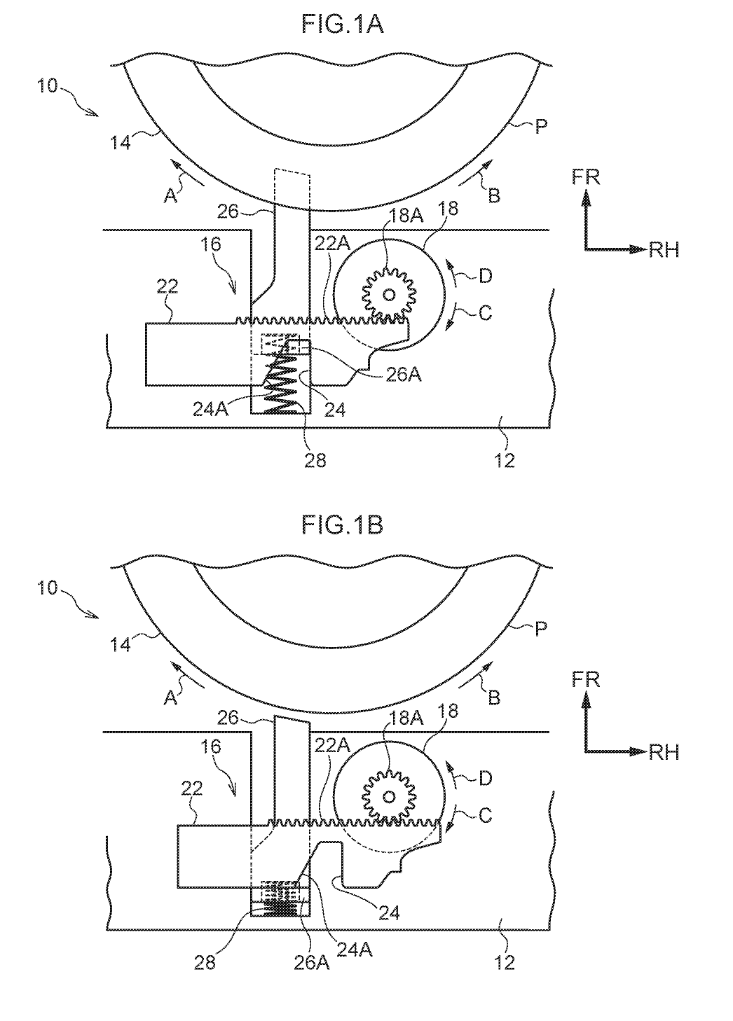

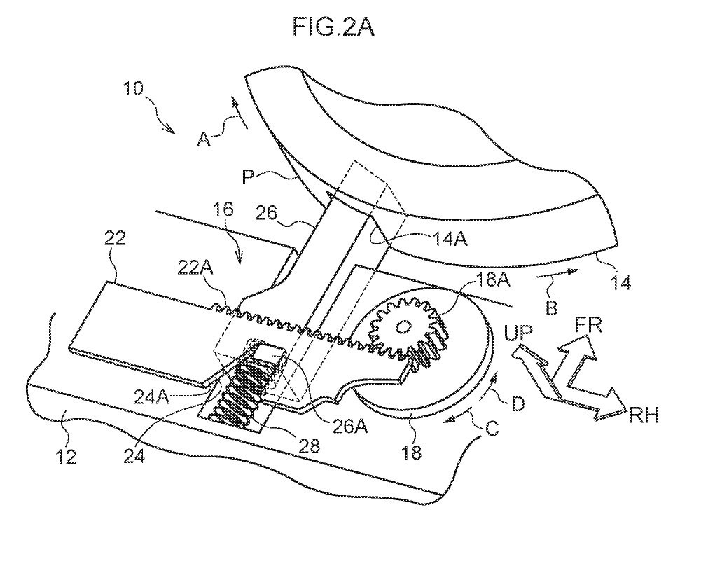

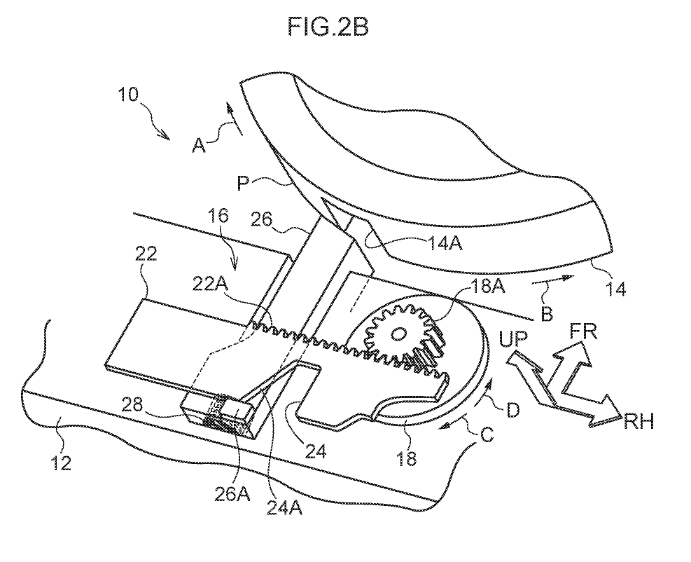

FIG. 1B is a plan view illustrating a shift device 10 according to a first exemplary embodiment of the present disclosure as viewed from above, and FIG. 2B is a perspective view of the shift device 10 as viewed obliquely from the rear right. Note that in the drawings, the arrow FR points toward the front of the shift device 10, the arrow RH points toward the right of the shift device 10, and the arrow UP points toward the upper side of the shift device 10.

The shift device 10 according to the present exemplary embodiment is installed to a console (not illustrated in the drawings) of a vehicle (automobile), and is disposed at the vehicle front and vehicle width direction inside of a driving seat (not illustrated in the drawings) of the vehicle. The front, right, and upper side of the shift device 10 respectively correspond to the front, right, and upper side of the vehicle.

As illustrated in FIG. 1B and FIG. 2B, a substantially rectangular box shaped plate 12, serving as a support body, is provided to the shift device 10. The plate 12 is fixed to an inner portion of the console, and the interior of the plate 12 is open toward the lower side.

A knob 14 with a bottomed, substantially circular tube shape and serving as a shift body (operation body) is supported at the upper side of the plate 12. The interior of the knob 14 is open toward the lower side, and the knob 14 is capable of rotating (moving) about an axis along the up-down direction. The knob 14 is capable of rotating in one direction (the arrow A direction in FIG. 1B, etc.) and another direction (the arrow B direction in FIG. 1B, etc.) over a predetermined range. The knob 14 is capable of being disposed at a P position (parking position), an R position (reverse position), an N position (neutral position), and a D position (drive position) serving as an example of shift positions (predetermined shift positions), in this sequence on progression from the other direction side to the one direction side. The knob 14 passes through the console so as to be capable of rotating and projects into a vehicle cabin. The knob 14 is rotation-operated by an occupant (specifically, the driver) of the vehicle.

A rectangular shaped lock hole 14A, serving as a restricted section, is formed through a lower end portion of a circumferential wall of the knob 14. The lock hole 14A is open toward the rear side of the knob 14 when the knob 14 is disposed at the P position.

A lock mechanism 16, serving as a restriction mechanism, is installed to the plate 12 at the rear side of the knob 14.

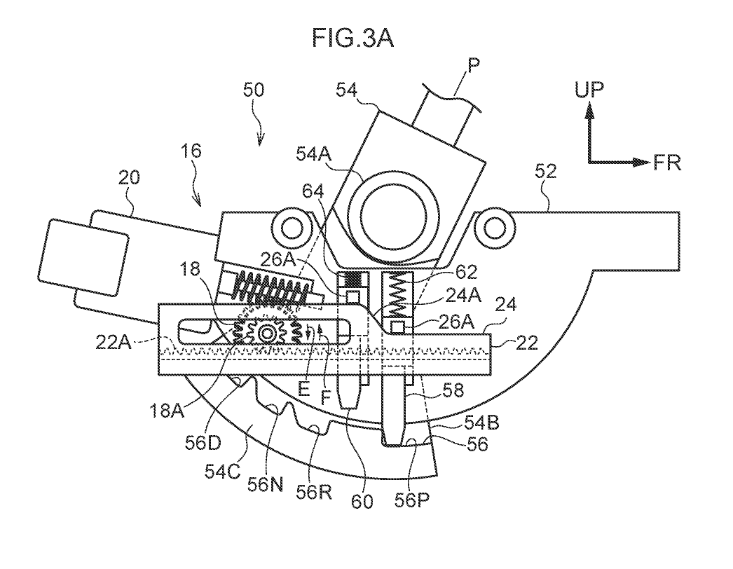

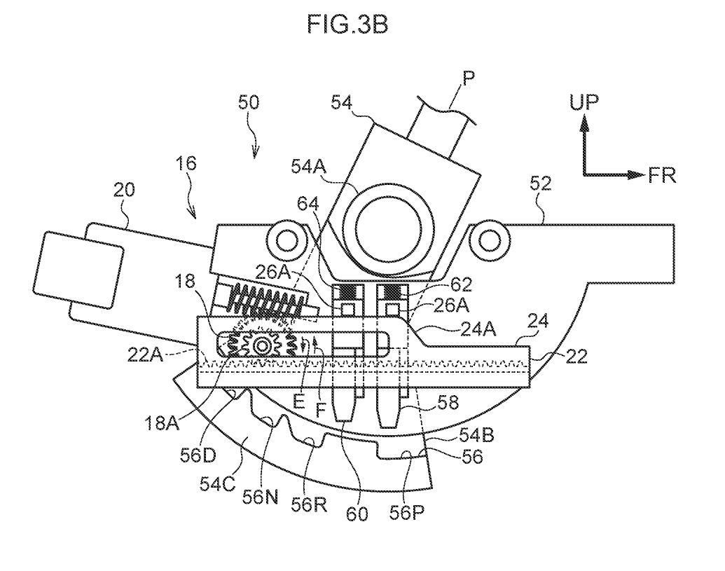

A pinion 18, serving as a moving gear, is provided to the lock mechanism 16. The pinion 18 is supported at the upper side of the plate 12 at the rear of a right side portion of the knob 14, and is capable of rotating about an axis along the up-down direction. Pinion teeth 18A are provided to an outer periphery of an upper side portion of the pinion 18. The pinion teeth 18A are disposed at uniform spacings about the circumferential direction of the pinion 18. A drive mechanism 20 (see FIG. 3A, etc.) is mechanically connected to the pinion 18. The drive mechanism 20 is supported by the plate 12, and is electrically connected to a controller (not illustrated in the drawings). The drive mechanism 20 is capable of being forward driven and reverse driven under the control of the controller. The drive mechanism 20 is forward driven to rotate the pinion 18 in a forward direction (the arrow C direction in FIG. 1B, etc.), and the drive mechanism 20 is reverse driven to rotate the pinion 18 in a reverse direction (the arrow D direction in FIG. 1B, etc.). A vehicle brake (not illustrated in the drawings) is also electrically connected the controller, and an occupant operates the brake to brake the vehicle.

A substantially elongated, rectangular plate shaped rack 22, serving as a sliding body, is provided to the lock mechanism 16. The rack 22 is supported at the upper side of the plate 12 at the rear of the pinion 18, and is disposed so as to be perpendicular to the up-down direction. The rack 22 is capable of sliding along the left-right direction, and the rack 22 is restricted from moving in the front-rear direction and up-down direction. Rack teeth 22A are provided at a front end of the rack 22. The rack teeth 22A are disposed at uniform spacings along the left-right direction. The rack teeth 22A mesh with the pinion teeth 18A of the pinion 18. The pinion 18 is rotated in the forward direction to slide the rack 22 toward the left, and the pinion 18 is rotated in the reverse direction to slide the rack 22 toward the right. A trapezoidal shaped engagement notch 24 is formed through a front-rear direction intermediate portion of the rack 22 such that the engagement notch 24 is open toward the rear. A left face of the engagement notch 24 configures a planar face shaped inclined face 24A. The inclined face 24A is inclined in a direction toward the front on progression toward the right.

A substantially rectangular column shaped lock bar 26, serving as a restriction body, is provided to the lock mechanism 16. The lock bar 26 is supported at the upper side of the plate 12 to the left of the pinion 18 and at the lower side of the rack 22. The lock bar 26 is capable of sliding (moving) along the front-rear direction. The lock bar 26 is restricted from moving in the left-right direction and the up-down direction. A rectangular block shaped engagement protrusion 26A, serving as an engagement section, is integrally provided to a rear-right corner of an upper face of the lock bar 26. The engagement protrusion 26A projects upward and is disposed at the rear of the rack 22.

A spring 28 (compression coil spring), serving as an urging member, is provided to the lock mechanism 16 at the rear of the lock bar 26. The spring 28 spans between the lock bar 26 and the plate 12, and urges the lock bar 26 toward the front. The engagement protrusion 26A of the lock bar 26 engages with (abuts) a rear end face of the rack 22 on the left of the engagement notch 24 due to the urging force of the spring 28, such that the lock bar 26 is disposed at the rear of the knob 14.

Explanation follows regarding operation of the present exemplary embodiment.

In the shift device 10 with the above configuration, in cases in which the knob 14 is disposed at the P position and the brake has not been operated, the drive mechanism 20 of the lock mechanism 16 is forward driven under the control of the controller, such that the pinion 18 rotates in the forward direction (arrow C direction) and the rack 22 slides toward the left. The engagement protrusion 26A of the lock bar 26 is thereby inserted into the engagement notch 24 of the rack 22 and rides rightward along the inclined face 24A of the engagement notch 24 due to the urging force of the spring 28, such that the lock bar 26 slides toward the front (one side) (see FIG. 1A and FIG. 2A). The lock bar 26 is thereby inserted into the lock hole 14A of the knob 14, such that the knob 14 is locked (restricted) from rotating from the P position toward the R position side by the lock bar 26.

In cases in which the knob 14 is disposed at the P position and the brake has been operated, the drive mechanism 20 of the lock mechanism 16 is reverse driven under the control of the controller, such that the pinion 18 rotates in the reverse direction (arrow D direction), and the rack 22 slides toward the right. The engagement protrusion 26A of the lock bar 26 thereby rides leftward along the inclined face 24A of the engagement notch 24 of the rack 22 and leaves the engagement notch 24 against the urging force of the spring 28, such that the lock bar 26 slides toward the rear (another side) (see FIG. 1B and FIG. 2B). The lock bar 26 is accordingly disinserted from the lock hole 14A, thereby releasing locking of rotation of the knob 14 from the P position toward the R position side by the lock bar 26.

Note that the pinion 18 (pinion teeth 18A) and the rack 22 (rack teeth 22A) mesh with each other, and that the pinion 18 is rotated to slide the rack 22 and thus to slide the lock bar 26. This enables the precision of the slide speed of the rack 22 with respect to the rotation speed of the pinion 18 to be increased, enabling the precision of the slide speed of the lock bar 26 to be increased, and enabling the precision of the operation duration when the lock mechanism 16 locks and releases locking of the knob 14 to be increased.

Furthermore, the inclined face 24A of the rack 22 is inclined with respect to the slide direction of the rack 22 (the left-right direction), and the inclined face 24A engages with the engagement protrusion 26A of the lock bar 26 such that the lock bar 26 slides when the rack 22 slides. Thus, the slide speed of the lock bar 26 with respect to the slide speed of the rack 22, and the slide amount of the lock bar 26 with respect to the slide amount of the rack 22, can be easily adjusted by adjusting the angle of incline of the inclined face 24A with respect to the slide direction of the rack 22. This also enables the degrees of freedom of the slide direction of the lock bar 26 with respect to the slide direction of the rack 22 to be increased, enabling the slide direction of the lock bar 26 to be easily changed.

Moreover, the engagement protrusion 26A of the lock bar 26 engages with the inclined face 24A of the rack 22 on a side in a direction perpendicular to the slide direction of the lock bar 26 (on the upper side). This enables the engagement protrusion 26A to engage with the inclined face 24A in a consistent manner during sliding of the rack 22 and the lock bar 26, and enables the sliding of the lock bar 26 to be stabilized.

The rack 22 slides at a rotation-circumferential direction side of the knob 14 (in the left-right direction). This enables the shift device 10 to be made smaller in size in a rotation-radial direction of the knob 14 (the front-rear direction).

Note that in the present exemplary embodiment, the lock bar 26 locks the knob 14 from rotating from the P position. However, the lock bar 26 may lock the knob 14 from rotating from a shift position other than the P position (such as the N position).

### Second Exemplary Embodiment

FIG. 3B is a side view illustrating a shift device 50 according to a second exemplary embodiment of the present disclosure as viewed from the right.

The shift device 50 according to the second exemplary embodiment of the present disclosure has basically the same configuration as the first exemplary embodiment, with the exception of the following points.

As illustrated in FIG. 3B, in the shift device 50 according to the present exemplary embodiment, a support frame 52, serving as a support member, is fixed to the inside of the plate 12. The support frame 52 is disposed so as to be perpendicular to the left-right direction. Note that the plate 12 is omitted from illustration in the present exemplary embodiment.

A substantially elongated rod shaped lever 54, serving as a shift body (operation body) is disposed within the plate 12. The lever 54 is disposed on the left of the support frame 52. A circular column shaped support shaft 54A is provided at an up-down direction intermediate portion of the lever 54. The lever 54 is supported by the support shaft 54A at an upper portion of the plate 12 so as to be capable of swinging (rotating, moving) over a predetermined range in the front-rear direction. The lever 54 passes through an upper wall of the plate 12 and through the console so as to be capable of being swung in the front-rear direction. The lever 54 extends into the vehicle cabin. The lever 54 is capable of being swing-operated by an occupant gripping an upper end portion (leading end portion) of the lever 54. The lever 54 is capable of being disposed at a P position, an R position, an N position, and a D position on progression from the front toward the rear.

A button (switch, not illustrated in the drawings), serving as an operation section, is provided at the upper end portion of the lever 54. The button is capable of being operated (press-operated) by the occupant, and is electrically connected to the controller.

A swinging plate 54B with a substantially spreading fan-like plate shape is provided at a lower portion of the lever 54. A lower face of the swinging plate 54B is curved along a swing-circumferential direction of the lever 54. A projection portion 54C is integrally provided at a lower end portion of the swinging plate 54B. The projection portion 54C extends along the swing-circumferential direction of the lever 54. The projection portion 54C projects toward the right side. The projection portion 54C passes below the support frame 52 and projects toward the right of the support frame 52.

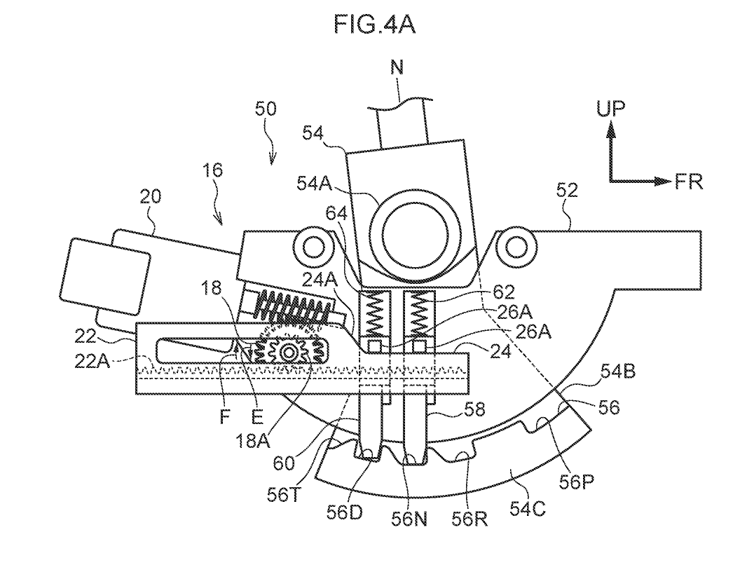

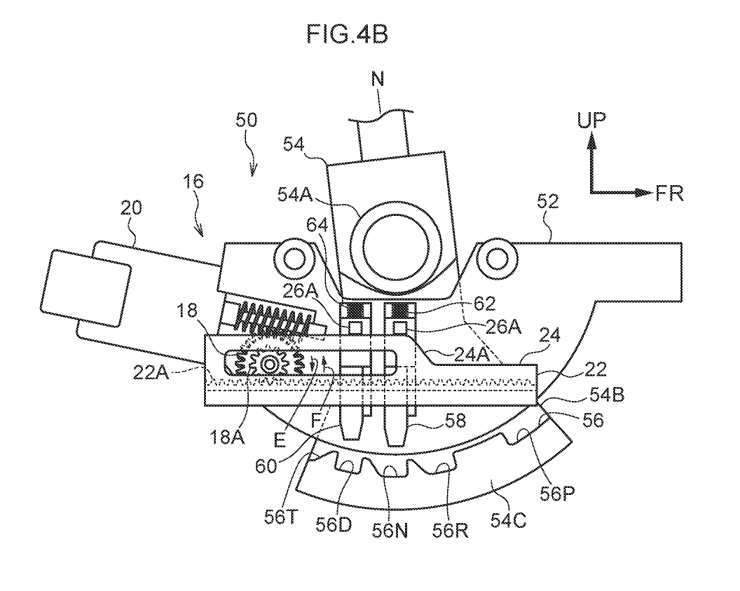

A detent groove 56 that has a predetermined shape and serves as a restricted section is formed at an upper face of the projection portion 54C. The detent groove 56 is disposed running along an extension direction of the projection portion 54C. A P groove 56P is formed at a front end portion of the detent groove 56. A rear face of the P groove 56P is disposed so as to be substantially perpendicular to the swing-circumferential direction of the lever 54. The detent groove 56 is formed with an R groove 56R at the rear of the P groove 56P. A front face of the R groove 56R is disposed so as to be substantially perpendicular to the swing-circumferential direction of the lever 54, and a rear face of the R groove 56R is inclined upward on progression toward the rear. The detent groove 56 is formed with an N groove 56N to the rear of the R groove 56R. A front face of the N groove 56N is disposed so as to be substantially perpendicular to the swing-circumferential direction of the lever 54, and a rear face of the N groove 56N is inclined upward on progression toward the rear. The detent groove 56 is formed with a D groove 56D (see FIG. 4B) to the rear of the N groove 56N. A front face and a rear face of the D groove 56D are disposed so as to be substantially perpendicular to the swing-circumferential direction of the lever 54. A placement groove 56T (see FIG. 4B) is formed at a rear end portion of the detent groove 56 (to the rear of the D groove 56D). A front face of the placement groove 56T is inclined in an upward direction on progression toward the front.

The pinion 18 of the lock mechanism 16 is supported at the right of a rear portion of the support frame 52 and is capable of rotating about an axis along the left-right direction. The pinion teeth 18A of the pinion 18 are provided at the outer periphery of a right side portion of the pinion 18. The drive mechanism 20 of the lock mechanism 16 is supported at the right of the rear portion of the support frame 52. The drive mechanism 20 is forward driven to rotate the pinion 18 in a forward direction (the arrow E direction in FIG. 3B, etc.), and the drive mechanism 20 is reverse driven to rotate the pinion 18 in a reverse direction (the arrow F direction in FIG. 3B, etc.).

The rack 22 of the lock mechanism 16 has a T-shaped columnar cross-section profile, and is supported at the lower-right of the pinion 18 and at the right side of the support frame 52. A right side portion of the rack 22 is disposed so as to be perpendicular to the left-right direction, and a left side portion of the rack 22 is disposed so as to be perpendicular to the up-down direction. The rack 22 is capable of sliding along the front-rear direction, and the rack 22 is restricted from moving along the up-down direction and the left-right direction. The rack teeth 22A of the rack 22 are provided to an upper face of the left side portion of the rack 22. The rack teeth 22A mesh with the pinion teeth 18A of the pinion 18. The pinion 18 is rotated in the forward direction to slide the rack 22 toward the rear, and the pinion 18 is rotated in the reverse direction to slide the rack 22 toward the front. A rear portion of the rack 22 is capable of configuring a released position, a front-rear direction intermediate portion of the rack 22 is capable of configuring a first locked position (first restriction position) as illustrated in FIG. 3A, and a front portion of the rack 22 is capable of configuring a second locked position (second restriction position) as illustrated in FIG. 4A. The engagement notch 24 of the rack 22 is formed through an upper-front side portion of the rack 22, and the engagement notch 24 is open toward the upper-front side. A rear face of the engagement notch 24 configures the inclined face 24A of the engagement notch 24. The inclined face 24A is inclined in a downward direction on progression toward the front.

A first lock bar 58 and a second lock bar 60, each having a substantially rectangular column shape and serving as a restriction body, are provided to the lock mechanism 16 in front of the pinion 18 and on the left of the rack 22. The first lock bar 58 and the second lock bar 60 are supported at the right side of the support frame 52, and the first lock bar 58 is disposed in front of the second lock bar 60. The first lock bar 58 and the second lock bar 60 are capable of sliding (moving) in the up-down direction, and the first lock bar 58 and the second lock bar 60 are restricted from moving in the front-rear direction and the left-right direction. Engagement protrusions 26A are integrally provided to an upper end portion of a right face of both the first lock bar 58 and the second lock bar 60. Each engagement protrusion 26A projects toward the right, and is disposed at the upper side of the rack 22.

A first spring 62 and a second spring 64 (compression coil springs), each serving as an urging member, are respectively provided to the lock mechanism 16 at the upper sides of the first lock bar 58 and the second lock bar 60. The first spring 62 and the second spring 64 respectively span between the first lock bar 58 and the support frame 52 and between the second lock bar 60 and the support frame 52, and urge the first lock bar 58 and the second lock bar 60 downward. The engagement protrusions 26A of the first lock bar 58 and the second lock bar 60 respectively engage with (abut) an upper end face of the rack 22 at the rear of the engagement notch 24 due to the respective urging forces of the first spring 62 and the second spring 64, such that the first lock bar 58 and the second lock bar 60 are disposed at the upper side of the detent groove 56 of the lever 54.

When the rack 22 slides to the rear from the released position to the first locked position, the engagement protrusion 26A of the first lock bar 58 is inserted into the engagement notch 24 of the rack 22 and rides forward along the inclined face 24A of the engagement notch 24 due to the urging force of the first spring 62, such that the first lock bar 58 slides toward the lower side (one side) (see FIG. 3A).

When the rack 22 slides to the front from the first locked position to the released position, the engagement protrusion 26A of the first lock bar 58 rides rearward along the inclined face 24A of the engagement notch 24 of the rack 22 and leaves the engagement notch 24 against the urging force of the first spring 62, such that the first lock bar 58 slides toward the upper side (another side) (see FIG. 3B).

When the rack 22 slides to the rear from the released position to the second locked position, the engagement protrusion 26A of the first lock bar 58 is inserted into the engagement notch 24 of the rack 22 and rides forward along the inclined face 24A of the engagement notch 24 due to the urging force of the first spring 62, such that the first lock bar 58 slides toward the lower side. Furthermore, the engagement protrusion 26A of the second lock bar 60 is inserted into the engagement notch 24 of the rack 22 and rides forward along the inclined face 24A of the engagement notch 24 due to the urging force of the second spring 64, such that the second lock bar 60 also slides toward the lower side (see FIG. 4A).

When the rack 22 slides to the front from the second locked position to the released position, the engagement protrusion 26A of the second lock bar 60 rides rearward along the inclined face 24A of the engagement notch 24 of the rack 22 and leaves the engagement notch 24 against the urging force of the second spring 64, such that the second lock bar 60 slides toward the upper side. Furthermore, the engagement protrusion 26A of the first lock bar 58 rides rearward along the inclined face 24A of the engagement notch 24 of the rack 22 and leaves the engagement notch 24 against the urging force of the first spring 62, such that the first lock bar 58 slides toward the upper side (see FIG. 4B).

Explanation follows regarding operation of the present exemplary embodiment.

In the shift device 50 with the above configuration, in cases in which the lever 54 is disposed at the P position and the brake has been operated, if the button on the lever 54 is not operated, the drive mechanism 20 of the lock mechanism 16 is forward driven under the control of the controller, such that the pinion 18 rotates in the forward direction (arrow E direction), and the rack 22 slides toward the rear to the first locked position. The first lock bar 58 thereby slides toward the lower side and is inserted into the P groove 56P of the detent groove 56 of the lever 54 (see FIG. 3A). Thus, if the lever 54 is swing-operated toward the rear from the P position such that the detent groove 56 swings toward the front, the rear face of the P groove 56P abuts the first lock bar 58 and the detent groove 56 is restricted from swinging toward the front by the first lock bar 58, thereby restricting (locking) the lever 54 from being swing-operated from the P position toward the R position side.

However, in cases in which the lever 54 is disposed at the P position and the brake has been operated, if the button on the lever 54 is also operated, the drive mechanism 20 of the lock mechanism 16 is reverse driven under the control of the controller, such that the pinion 18 rotates in the reverse direction (arrow F direction), and the rack 22 slides toward the front to a swing-permitted position. The first lock bar 58 thereby slides toward the upper side and is disposed at the upper side of the detent groove 56 of the lever 54 (see FIG. 3B). Thus, if the lever 54 is swing-operated toward the rear from the P position, the detent groove 56 is permitted to swing toward the front, and the lever 54 is permitted to be swing-operated from the P position toward the R position side.

In cases in which the lever 54 is disposed at the R position, if the button on the lever 54 is not operated, the drive mechanism 20 of the lock mechanism 16 is forward driven under the control of the controller, such that the pinion 18 rotates in the forward direction (arrow E direction), and the rack 22 slides toward the rear to the first locked position. The first lock bar 58 thereby slides downward and is inserted into the R groove 56R of the detent groove 56 of the lever 54. Thus, if the lever 54 is swing-operated toward the front from the R position such that the detent groove 56 swings toward the rear, the front face of the R groove 56R abuts the first lock bar 58 and the detent groove 56 is restricted from swinging toward the rear by the first lock bar 58, thereby restricting the lever 54 from being swing-operated from the R position toward the P position side.

If the lever 54 is swing-operated toward the rear from the R position such that the detent groove 56 swings forward when the button on the lever 54 is not operated, the first lock bar 58 slides upward against the urging force of the first spring 62 due to the first lock bar 58 riding along the rear face of the R groove 56R. If the lever 54 is then swing-operated to the N position, the N groove 56N of the detent groove 56 reaches the first lock bar 58, such that the first lock bar 58 slides downward due to the urging force of the first spring 62 and the first lock bar 58 is inserted into the N groove 56N.

In cases in which the lever 54 is disposed at the R position, if the button on the lever 54 is operated, the drive mechanism 20 of the lock mechanism 16 is reverse driven under the control of the controller, such that the pinion 18 rotates in the reverse direction (arrow F direction), and the rack 22 slides toward the front to the swing-permitted position. The first lock bar 58 thereby slides upward and to be disposed at the upper side of the detent groove 56 of the lever 54. Thus, if the lever 54 is swing-operated toward the front or rear from the R position, the detent groove 56 is permitted to swing toward the rear or front respectively, and the lever 54 is permitted to be swing-operated from the R position toward the P position side or the N position side.

In cases in which the lever 54 is disposed at the N position, if the button on the lever 54 is not operated, the drive mechanism 20 of the lock mechanism 16 is forward driven under the control of the controller, such that the pinion 18 rotates in the forward direction (arrow E direction), and the rack 22 slides toward the rear to the second locked position. The first lock bar 58 thereby slides downward and is inserted into the N groove 56N of the detent groove 56, and the second lock bar 60 also slides downward and is inserted into the D groove 56D of the detent groove 56 (see FIG. 4A). Thus, if the lever 54 is swing-operated toward the rear from the N position such that the detent groove 56 swings toward the front, the rear face of the D groove 56D abuts the second lock bar 60 and the detent groove 56 is restricted from swinging toward the front by the second lock bar 60, thereby restricting the lever 54 from being swing-operated from the N position toward the D position side. Furthermore, if the lever 54 is swing-operated toward the front from the N position such that the detent groove 56 swings toward the rear, the front face of the N groove 56N abuts the first lock bar 58 and the detent groove 56 is restricted from swinging toward the rear by the first lock bar 58, thereby restricting the lever 54 from being swing-operated from the N position toward the R position side.

In cases in which the lever 54 is disposed at the N position, if the button on the lever 54 is operated, the drive mechanism 20 of the lock mechanism 16 is reverse driven under the control of the controller, such that the pinion 18 rotates in the reverse direction (arrow F direction), and the rack 22 slides to the front to the swing-permitted position. The first lock bar 58 and the second lock bar 60 thereby slide upward to be disposed at the upper side of the detent groove 56 (see FIG. 4B). Thus, if the lever 54 is swing-operated toward the rear or front from the N position, the detent groove 56 is permitted to swing toward the front or rear respectively, and the lever 54 is permitted to be swing-operated from the N position toward the D position side or the R position side.

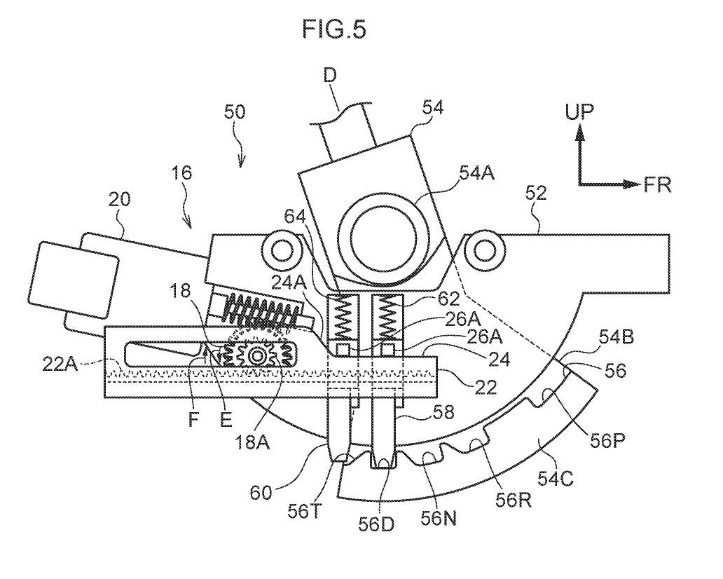

In cases in which the lever 54 is disposed at the D position, if the button on the lever 54 is not operated, the drive mechanism 20 of the lock mechanism 16 is forward driven under the control of the controller, such that the pinion 18 rotates in the forward direction (arrow E direction), and the rack 22 slides toward the rear to the second locked position. The first lock bar 58 thereby slides downward and is inserted into the D groove 56D of the detent groove 56, and the second lock bar 60 also slides downward and is inserted into the placement groove 56T of the detent groove 56 (see FIG. 5). Thus, if the lever 54 is swing-operated toward the front from the D position such that the detent groove 56 swings toward the rear, the front face of the D groove 56D abuts the first lock bar 58 and the detent groove 56 is restricted from swinging toward the rear by the first lock bar 58, thereby restricting the lever 54 from being swing-operated from the D position toward the N position side.

In cases in which the lever 54 is disposed at the D position, if the button on the lever 54 has been operated, the drive mechanism 20 of the lock mechanism 16 is reverse driven under the control of the controller, such that the pinion 18 rotates in the reverse direction (arrow F direction), and the rack 22 slides to the front to the swing-permitted position. The first lock bar 58 and the second lock bar 60 thereby slide upward and are disposed at the upper side of the detent groove 56. Thus, if the lever 54 is swing-operated toward the front from the D position, the detent groove 56 is permitted to swing toward the rear, and the lever 54 is permitted to be swing-operated from the D position toward the N position side.

Note that the pinion 18 (pinion teeth 18A) and the rack 22 (rack teeth 22A) mesh with each other, and that the pinion 18 is rotated to slide the rack 22 and thus to slide the first lock bar 58 and the second lock bar 60. This enables the precision of the slide speed of the rack 22 with respect to the rotation speed of the pinion 18 to be increased, enabling the precision of the slide speeds of the first lock bar 58 and the second lock bar 60 to be increased, and enabling the precision of the operation duration when the lock mechanism 16 locks and releases locking of the lever 54 to be increased.

Furthermore, the inclined face 24A of the rack 22 is inclined with respect to the slide direction of the rack 22 (the left-right direction), and the inclined face 24A engages with the engagement protrusions 26A of the first lock bar 58 and the second lock bar 60 to slide the first lock bar 58 and the second lock bar 60 when the rack 22 slides. Thus, the slide speeds of the first lock bar 58 and the second lock bar 60 with respect to the slide speed of the rack 22 and the slide amounts of the first lock bar 58 and the second lock bar 60 with respect to the slide amount of the rack 22 can be easily adjusted by adjusting the angle of incline of the inclined face 24A with respect to the slide direction of the rack 22. This also enables the degrees of freedom of the slide directions of the first lock bar 58 and the second lock bar 60 with respect to the slide direction of the rack 22 to be increased, enabling the slide directions of the first lock bar 58 and the second lock bar 60 to be easily changed.

Moreover, the engagement protrusions 26A of the first lock bar 58 and the second lock bar 60 engage with the inclined face 24A of the rack 22 on a side in a direction perpendicular to the slide direction of the first lock bar 58 and the second lock bar 60 (on the right side). This enables the engagement protrusions 26A to engage with the inclined face 24A in a consistent manner during sliding of the rack 22, the first lock bar 58, and the second lock bar 60, and enables the sliding of the first lock bar 58 and the second lock bar 60 to be stabilized.

The rack 22 slides at a swing-circumferential direction side of the lever 54 (in the front-rear direction). This enables the shift device 50 to be made smaller in size in a swing-radial direction of the lever 54 (the up-down direction).

Furthermore, the rack 22 slides in order to slide both the first lock bar 58 and the second lock bar 60. This enables a configuration with which both the first lock bar 58 and the second lock bar 60 are made to slide to be simplified, enabling the shift device 50 to be made smaller in size.

Note that in the present exemplary embodiment, in cases in which the lever 54 is disposed at the P position, the lever 54 is permitted to swing from the P position if the button on the lever 54 is operated when the brake has been operated. However, in cases in which the lever 54 is disposed at the P position, the lever 54 may permitted to swing from the P position either if the brake has been operated or if the button on the lever 54 has been operated.

Furthermore, in the present exemplary embodiment, the first lock bar 58 and the second lock bar 60 are made to slide by the same inclined face 24A of the rack 22. However, the first lock bar 58 and the second lock bar 60 may be made to slide by different inclined faces 24A of the rack 22.

In the first exemplary embodiment and second exemplary embodiment described above, the lock hole 14A and the detent groove 56 are respectively provided to the knob 14 and the lever 54, and the lock mechanism 16 is provided on the vehicle body side (to the plate 12 or the support frame 52). However, the lock mechanism 16 may be provided to the knob 14 or the lever 54, and the lock hole 14A or the detent groove 56 may be provided on the vehicle body side.

In the first exemplary embodiment and second exemplary embodiment described above, the rack 22 slides at a rotation-circumferential direction side of the knob 14 or the lever 54. However, the rack 22 may slide at a rotation-axial direction side of the knob 14 or the lever 54.

In the first exemplary embodiment and second exemplary embodiment described above, the inclined face 24A of the rack 22 has a planar face profile. However, the inclined face 24A of the rack 22 may have a bent face profile (such as a curved face profile).

In the first exemplary embodiment and second exemplary embodiment described above, the inclined face 24A is provided to the rack 22. However, it is sufficient that the inclined face 24A be provided to at least one out of the rack 22 or the lock bar 26, or at least one out of the rack 22 or the first lock bar 58 and the second lock bar 60.

In the first exemplary embodiment and second exemplary embodiment described above, the knob 14 (shift body) is capable of rotating about its central axis line, and the lever 54 (shift body) is capable of swinging about the support shaft 54A. However, a shift body may be configured so as to be capable of sliding.

In the first exemplary embodiment and second exemplary embodiment described above, the shift device 10, 50 is installed to a console in the vehicle cabin. However, the shift device 10, 50 may be installed to a column cover or an instrument panel in the vehicle cabin.

What is claimed is:

1. A shift device comprising:
a shift body that is moved to change a shift position;
a restriction body that is moved toward one side to restrict movement of the shift body from a predetermined shift position, and that is moved toward another side to release restriction of movement of the shift body from the predetermined shift position;
a moving gear that is capable of rotating; and
a sliding body that meshes with the moving gear, and that slides, due to the moving gear being rotated, so as to move the restriction body.

2. The shift device of claim 1, further comprising:
an inclined face that is provided at at least one of the restriction body or the sliding body, that is inclined with respect to a sliding direction of the sliding body, and that, by engaging with another of the restriction body or the sliding body, slides the sliding body to move the restriction body.

3. The shift device of claim 1, wherein the sliding body slides at a rotation-circumferential direction side or a rotation-axial direction side of the shift body.

4. The shift device of claim 2, wherein the sliding body slides at a rotation-circumferential direction side or a rotation-axial direction side of the shift body.

5. The shift device of claim 1, wherein the sliding body slides to move a plurality of restriction bodies.

6. The shift device of claim 2, wherein, with respect to the sliding direction, the inclined face has an angle of incline determined according to a movement speed of the restriction body with respect to a sliding speed of the sliding body.

7. The shift device of claim 2, wherein the inclined face is provided at the sliding body, and the restriction body includes an engagement protrusion to engage with the inclined face.
